(19) United States
(12) Patent Application Publication
(10) Pub. No.: US 2007/0169990 A1
(43) Pub. Date: Jul. 26, 2007

(54) Jet engine

(75) Inventor: Kakuya Iwata, Ibaraki (JP)

Correspondence Address: MORGAN LEWIS & BOCKIUS LLP, 1111 PENNSYLVANIA AVENUE NW, WASHINGTON, DC, 20004, US

(73) Assignee: National Institute of Advanced Industrial Science and Technology

(21) Appl. No.: 11/520,627

(22) Filed: Sep. 14, 2006

(30) Foreign Application Priority Data
Jan. 26, 2006 (JP) P.2006-017011

(51) Int. Cl. F02K 1/82

(52) U.S. Cl. 181/213

(57) ABSTRACT

The exhaust temperature of the jet engine is set up to 750° C. so that a fiber group sound absorber member such as glass fibers having a high sound-proofing performance can be used by cooling it with bypass air. In order to prevent the fibers from being scattered by a jet flow, a boundary is covered with a mesh metal to form a boundary layer with the bypass air, so that the fiber group sound absorber member can be protected against the jet flow of a high temperature and a high speed and so that the sound-proofing effect of the excellent fiber group sound absorber member can be kept. Moreover, the sound absorber member is prepared by combining sound absorber members of different frequency characteristics, thereby to realize a remarkably high sound-proofing performance exceeding 200 dB.

### BACKGROUND OF THE INVENTION

The present invention relates a jet engine of small size, light weight, high output, low vibration and high reliability, which is enabled to operate extremely near a man such as within a range of 2 m by reducing the noise and the temperature of the jet engine.

In 21th century, the transfers of traffic facilities from public ones to personal ones are becoming causes for changing the living environmental structures and the social structures drastically as suburban retail trades in the narrow national land of Japan. However, these transfers of the traffic facilities from the public to the personal are realized only on the land. This belongs to only the technical problem. With a sufficient technical backup, if any, the transfers of the aerial traffic facilities, which are only public at present, to the personal ones are believed to occur. The technique for solving that technical problem has been proposed in JP-A-2005-138641 (Patent Document 1). By applying this technique, it is possible to acquire the means for a man to go freely in the air. This means has to be backed up by an engine, which allows a man to fly freely in the air.

Here in JP-A-11-301596 (Patent Document 2), there is disclosed a technique on a jet engine silencing device, which is called the fence type engine runup silencing device. However, this technique relates not to an internal structure of the jet engine but to a silencing technique for silencing the jet engine on the ground with a fence.
[Patent Document 1] JP-A-2005-138641
[Patent Document 2] JP-A-11-301596
[Non-Patent Document 1]

“Investigations (1st Report) on Space Moving Robot” written by Hiroya Iwata, Association of Measurement Automation Control, Papers of Lectures of System Integration Branch, 2004

The propeller propulsion employed in the conventional small airplane uses a propeller having a diameter of 1 m or more so that it is remarkably dangerous for the persona use. In addition, most propeller propulsion airplanes use piston engines so that they have high vibrations to lower the reliabilities of the engines themselves and the electronic devices.

Moreover, the engine to be used for the traffics to transport a small number of persons is required to have the following strict conditions:

1. Small size; 2. Light Weight; 3. High Output; 4. Low Vibration; 5. Low Noise; 6. Safety; and 7. Reliability.

The most possible conventional art for this engine a jet engine or an electric fan. However, this electric fan finds it difficult to solve the problem of the light weight including the battery. On the other hand, the jet engine has problems in the noises especially at a high speed rotation and in the temperature rise in the gas, and finds it important to retain the safety.

### SUMMARY OF THE INVENTION

Therefore, the present invention has a main object to provide a jet engine which is made safe in the injected exhaust gas by reducing the influences of heat, and an object to provide a jet engine which is suited especially for a small airplane.

The present invention is a technique for adding a low noise and a safety by lowering the exhaust gas temperature, to a jet engine of a small size, a light weight, a high output, a low vibration and a high reliability so that the jet engine can operate extremely near a man.

At first, there are described the features of the small size, the light weight, the high output, the low vibration and the high reliability intrinsically belonging to the jet engine are described. The jet engine has a structure including a compressor, a combustor and a turbine so that it operates only with the rotational motions. As a result, the jet engine has far less vibrations than those of the internal combustion engine having reciprocating pistons. Moreover, the jet engine of the traffic facilities for personal uses has a thrust of about 500 N so that it has a small compressor diameter and a high rotation speed. Therefore, the vibrations are more lowered than those of the jet engine of the conventional art. The low vibration means that the stresses at the individual portions become relatively constant to the time axis so that they provide a high reliability. Moreover, the jet engine has a high output per weight next to that of a rocket engine so that it has a high output in a small size and with a light weight.

However, in addition to the compression of the intake air, a jet flow of a high speed is generated by the thermal expansion accompanying the combustion, with a defect that a large noise is generated. Moreover, the jet engine for the personal traffic facilities is arranged near the man, and rotates at a high speed. As a result, this high-frequency noise from the compressor obstructs the practical use of the jet engine.

In order to solve these problems, the noise insulation has to be made, but this noise insulation and the retention of the jet flow speed are contrary to each other. If the noise insulation is made complete, the flow speed is theoretically zero to raise a contradiction that the jet engine cannot be used as an engine. In the conventional art, a jet airplane carrying the jet engine is so large-sized that the engine is spaced and blocked from a passenger compartment being pressurized. Therefore, the noise prevention is thought sufficient, if it is solved near an airport. Therefore, the noise insulation of the jet engine of the conventional art is performed at the time of increasing the bypass flow and mixing the ambient air through a metallic diffuser and by means of a noise absorber called the “lining” having a honeycomb member reinforced by a porous surface material. In the structure of the large-sized jet engine of the conventional art, the honeycomb is sandwiched by a back skin and the porous metal sheet or composite member.

In the jet engine for the personal traffic facilities, the noise source itself is small because of the small engine size, but the man has to exist near the engine and to be light, so that the structure like that of the jet engine of the conventional art cannot be adopted.

According to the invention, therefore, there is adopted the means, as has been nonsense in the conventional art, for using the glass fibers in the exposed state, although the glass fibers have never been employed in the jet engine. Thus, the jet engine can realize the drastically low noise with the low weight and can make no one feel hot, even touched, by the improvement in the insulation. Moreover, the jet engine for the personal traffic facilities sets the combustion temperature to the heat resisting maximum for the refractory metal of nickel group. Thus, the jet engine is characterized in that the glass fibers can thermally stand only with the cooling boundary layer by the bypass air.

In order to solve the problems thus far described, therefore, according to the present invention, there is provided a jet engine including: a combustor unit arranged at a center thereof; an intake compressor; a combustor; a turbine for driving the intake compressor; and a fiber sound absorber member disposed on the inner circumference of an intake duct around the suction side of the combustor unit and an exhaust duct around the exhaust side of the combustor unit, the fiber sound absorber member being covered with a net for keeping the shape of the duct inner surface and having a surface exposed to the inside of the duct.

Further, there is provided the jet engine, further including: a fiber sound absorber member disposed on the inner circumference of an intake duct around the suction side of the combustor unit.

Further, there is provided the jet engine, wherein the fiber sound absorber member is glass wool.

Further, there is provided the jet engine, further including: a second sound absorber member having a sound absorbing frequency band different from that of the fiber sound absorber member, the second sound absorber member being disposed around the fiber sound absorber member.

Further, there is provided the jet engine, further including: a second sound absorber member having a heat resisting temperature different from that of the fiber sound absorber member, the second sound absorber member being disposed around the fiber sound absorber member.

Further, there is provided the jet engine, wherein the second sound absorber member is made of a foamed material.

Further, there is provided the jet engine, wherein the foamed material is foamed polyurethane.

Further, there is provided the jet engine, wherein the foamed material is foamed metal.

Further, there is provided the jet engine, further including: a third sound absorber member having a sound absorbing frequency band or a heat resisting temperature different from at least the second sound absorber member, the third sound absorber member being disposed around the second sound absorber member.

Further, there is provided the jet engine, wherein a bypass air flow from the intake port for bypassing the combustor is guided in the inner face of the fiber sound absorber member.

Further, there is provided the jet engine, wherein the bypass air flow cools the sound absorber member.

Further, there is provided the jet engine, wherein the bypass air flow suppresses the exhaust resistance by covering the surface of the sound absorber member with a low-temperature air boundary layer.

Further, there is provided the jet engine, wherein the net covering the duct surface is made of a meshed refractory metal.

Further, there is provided the jet engine, further including: an intake cone disposed a the center of the intake duct of the combustor unit; and a sound absorber member disposed in the intake cone.

Further, there is provided the jet engine, wherein the outer circumference section of the intake cone is equal to or larger than the outer circumference of the combustor unit.

Further, there is provided the jet engine, wherein fibers are used as the sound absorber member to lower the noise; an air boundary layer of low noise is formed by the bypass air flow to lower the temperature; and the protection at the turbine broken time is ensured by the double-casing having the second sound absorber member and by the meshed refractory metal is given to make the operation extremely near a man.

Further, there is provided the jet engine, wherein a hydrogen gas under a high pressure is used as a fuel.

The jet engine of the low noise, the low temperature, the small size, the light weight, the high output, the low vibration and the high reliability of the present invention is enabled, by using the inexpensive and simple traffic facilities of personal use, not to contribute to realization of the air personal traffic facilities but also to be applied to the unmanned air physical distribution system because of its safety, so that the safety even at the engine stop can be retained.

### BRIEF DESCRIPTION OF THE DRAWINGS

FIG. 1 is a section showing an embodiment of a jet engine of low noise, low temperature, small size, light weight, high output, low vibration and high reliability according to the invention.

FIG. 2 is an embodiment of a space moving robot utilizing the invention.

FIG. 3 is an embodiment of a space moving robot utilizing the invention.

FIG. 4 is an embodiment of a space moving robot utilizing the invention.

FIG. 5 is an explanatory diagram of the relations between the sum of the fuel weight and the engine weight and the flight time of a piston engine and a jet engine.

FIG. 6 is a diagram presenting the results of noise measurements at the front of the engine.

FIG. 7 is a diagram presenting the results of noise measurements at the side of the engine.

FIG. 8 is a diagram presenting the results of noise measurements at the back of the engine.

FIG. 9 is a diagram presenting the volume distribution at the maximum output of a twin type jet engine.

FIG. 10 is a diagram illustrating noise propagation characteristics of the jet engine.

FIG. 11 is a diagram presenting the frequency dependency of the propagation loss characteristics of the composed sound-proofing structures of the two kinds.

FIG. 12 is a diameter showing the parameters of two numerical values of a buried height and an intake port diameter of the triangular cone structure.

FIG. 13 is a diagram plotting the derivation of the Height parameter value exceeding the exhaust section area.

FIG. 14 is a diagram plotting the calculation results, in which the intake section area is plotted against the parameter of the air intake diameter.

FIGS. 15A and 15B are diagrams showing the comparison between the air intake before and after optimized.

FIG. 16 is a diagram presenting the sound-proofing effect measurement at the front of the engine.

FIG. 17 is a diagram presenting the sound-proofing effect measurement results at the side of the engine.

FIG. 18 is a diagram presenting the sound-proofing effect measurement at the back of the engine.

FIG. 19 is a diagram presenting the direction distribution characteristics of the noise reductions.

### DETAILED DESCRIPTION OF THE PREFERRED EMBODIMENTS

The invention succeeds in the drastic noise reduction to 20 dB by manufacturing the sound-proofing structure using the glass fibers, which have been accepted as unusable on principle as the existing sound-proofing structure of the jet engine. More specifically, the invention is realized by a jet engine comprising a combustor unit arranged at its center and including an intake compressor, a combustor and a turbine for driving the intake compressor. In the jet engine, a sound absorber member of fibers is so disposed on the inner circumferences of an intake duct around the suction side of the combustor unit and an exhaust duct around the exhaust side of the combustor unit as is covered with a net for keeping the shape of the duct inner surface and as has its surface exposed to the inside of the duct.

### Embodiment 1

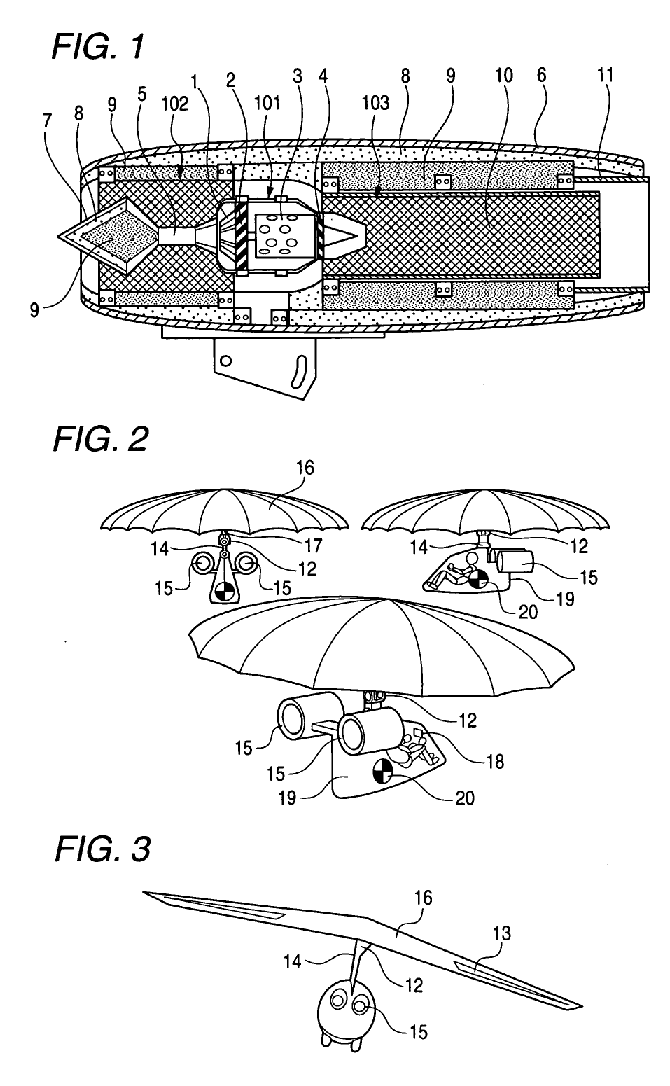

FIG. 1 is an explanatory view of an embodiment of a jet engine of low noise, low temperature, small size, light weight, high output, low vibration and high reliability of the present invention. In FIG. 1: numeral 1 designates a compressor rotor blade for compressing intake air; numeral 2 a compressor stator blade for compressing the intake air; numeral 3 an annular type combustor; and numeral 4 a turbine of a refractory nickel alloy for driving the compressor rotor blade. These elements constitute a combustor unit 101. Numeral 5 designates an electric motor for starting the jet engine and cleaning the same after stop; numeral 6 a casing of the jet engine of low noise, low temperature, small size, light weight, high output, low vibration and high reliability; and numeral 7 a sound-proofing cone for preventing the propagation of the noise from the compressor due to the nonreflection thereby to straighten the bypass air. Moreover: numeral 8 designates a sound absorber made of glass fibers and acting as a third sound absorber; numeral 9 a sound absorber made of foamed polyurethane and acting as a second sound absorber; numeral 10 a first sound absorber having a mesh metal structure for holding the shape of the sound absorber of fibers and for keeping the reduction of the flow velocity of a jet; and numeral 11 an exhaust nozzle. The duct is formed to enclose the combustor unit 101 and includes an intake duct 102 arranged in front of the combustor and an exhaust duct 103 arranged on the back. These ducts are provided on their inner circumferences with the aforementioned first sound absorber 10.

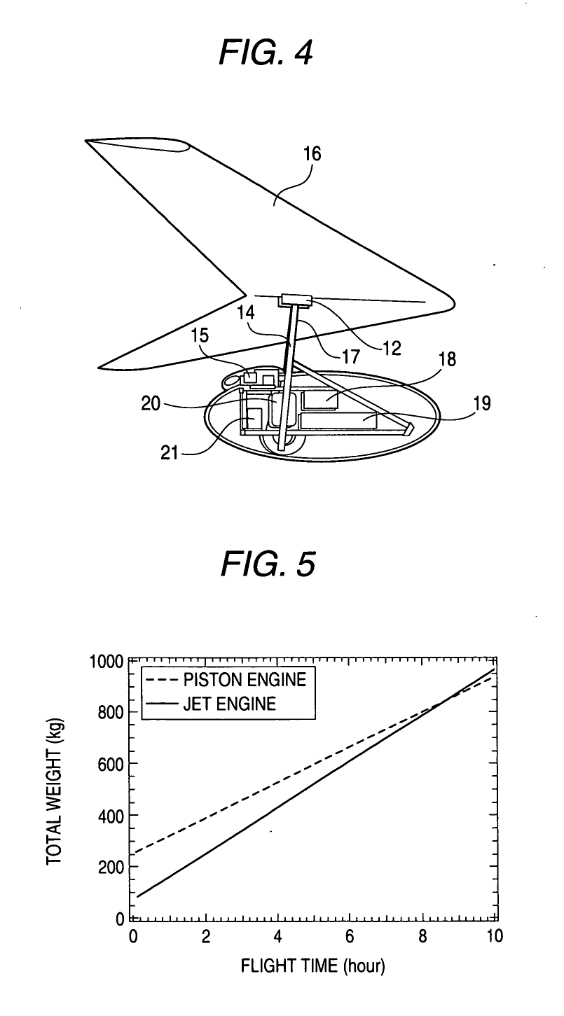

The flow of techniques to progress from machines through electronically controlled machines to robots is penetrating at present into all transportation machines including automobiles. Of these, the aerial mobility (or aviation) having less collision risks excepting those at the takeoff or landing time has already been in the robotic progress for military uses. The invention assumes as its applications the system, in which the aerial space is industrially utilized at a low risk by constituting the personal traffic system lightening the takeoff or landing risks in the air. The invention is practiced as the power for a flying vehicle suited for that system or for a space moving robot, and assumes its fields of applications, as shown in FIGS. 2, 3 and 4.

The performances required for the flying vehicle to be released from the takeoff or landing risks are the three points: a low stalling speed, a low sinking rate and the use of the jet engine. For the low stalling speed of those requirements, the retention of safety for the stalling is essential so long as the principle employing the lift is used, and the safety is drastically enhanced to facilitate the takeoff or landing by suppressing the stalling speed to 25 Km/hour or less. If the maximum speed at the collision time is lowered, moreover, the effectiveness of a passive collision safety device such as an airbag can be enhanced. For the low sinking rate, on the other hand, the safety of not only the robot itself but also the obstacle is retained in combination with the passive collision safety device such as the air bag, if the dynamic falling speed is equivalent to that of parachute although all the power sources or electric powers cannot be used. The use of the jet engine is taught by the spread of marine jets in recent years, because it is essential for spreading into the human society that the flying vehicle has no exposed object rotating at a high speed, such as a propeller. The advantages of the jet engine of the small size and light weight but the high output, the air-cooled, the low-inflammability fuel and the low NOx emission are suited for the robotization. The invention contemplates to provide such jet engine. The space moving robot has a unique structure, in which a wing and a body are connected through one robot articulation, as shown in FIGS. 2, 3 and 4, and is flown by the thrust of the jet engine of the invention. The maximum defects concomitant with the jet engine are the fuel cost and the noise. The following embodiments are the answers for those problems and are verified by experiments.

The results of investigations on the fuel cost of the jet engine are described in the following. The specifications of the piston engine and the jet engine, as used for the investigations and having similar outputs, are tabulated in Table 1. The relations between the sum of the fuel weight and the engine weight and the flight time at the time of using those engines are presented in FIG. 5.

TABLE 1

| | Piston Engine | Jet engine |
|---|---|---|
| Engine name | O-520 | 250-C20B |
| Constructor | continental | Alison |
| Max power | 390 hp | 420 hp |
| Usual power | 274 hp | 278 hp |
| Fuel Consumption | 250 g/hp/h | 322 g/hp/h |
| Engine weight | 254 kg | 72 kg |

The space moving robot, as intended to have the jet engine of the invention mounted thereon, has a final object as the final object, and is imagined to have a flight range of 1,000 Km or less and the maximum speed of 150 Km/hour or less but not to operate 8 hours or longer. From this, as seen from FIG. 5, the jet engine can be lighter and more efficient even in consideration of the fuel cost, and it is found from the weight column of Table 1 that the drastically light weight characteristics exhibit the effects.

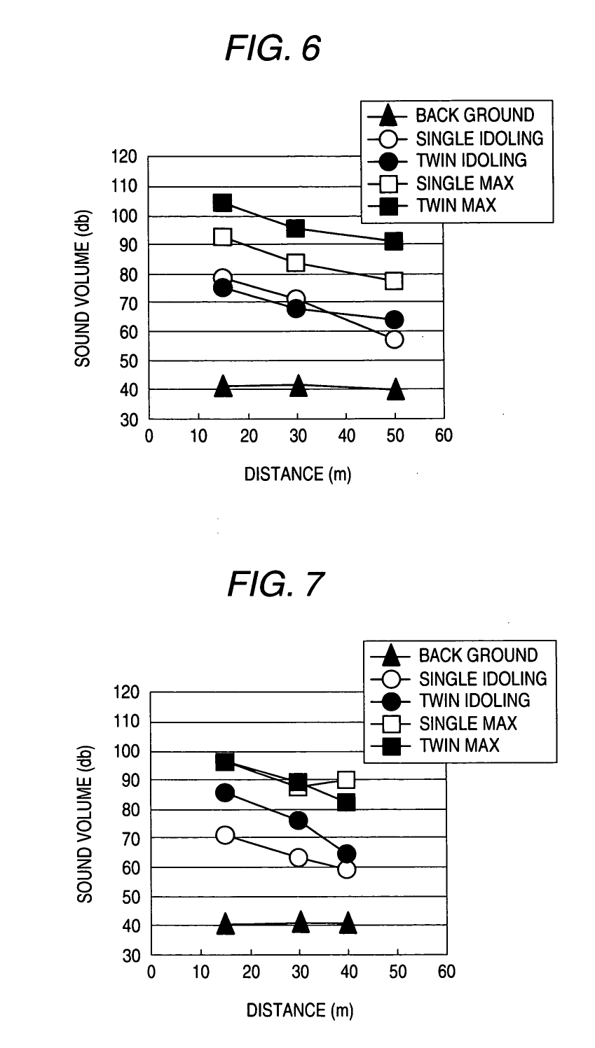

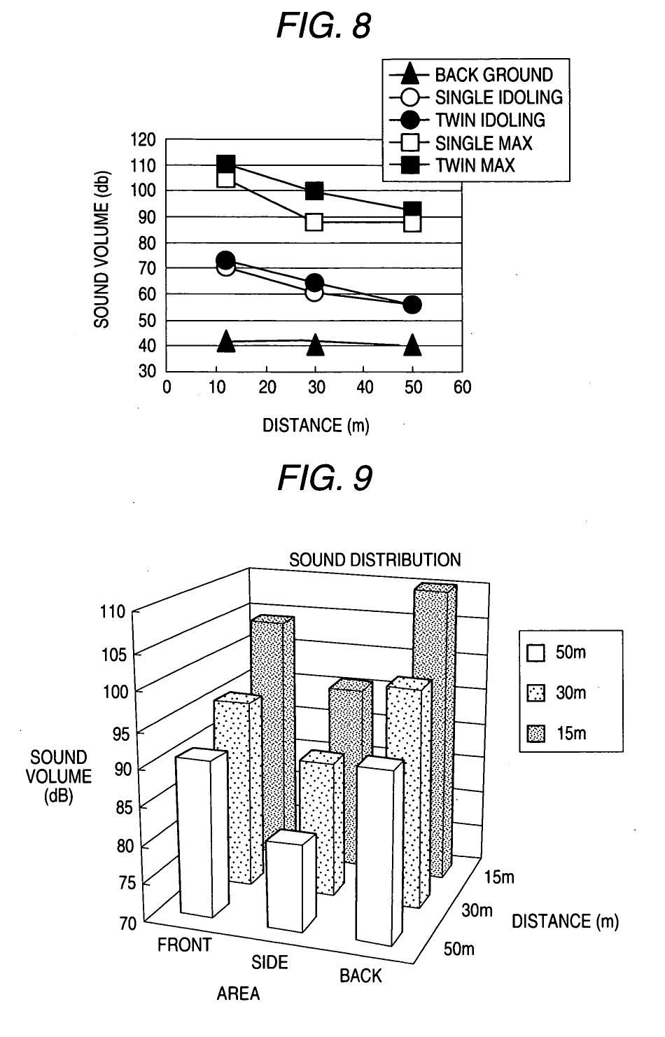

The results of the noise measurements with only the jet power are described in the following. The solutions for the measures against the hardest problem or the noise with the jet engine have been verified by experiments. At first, the noise is measured on the jet engine in the state having no countermeasure against the noise. FIGS. 6, 7 and 8 present the measurement results at the front, the side and the back of the engine, respectively. Only the side measurement results of FIG. 6 have the maximum distance of 40 m for the conveniences of measurement space. The sound volume naturally becomes the lower as the distance becomes the longer. It should be noted that an exception to the tendency is in the measurement results of the side of FIG. 7.

Next, the volume distribution of the twin type jet engine is presented in FIG. 9. FIG. 9 clarifies the volume distribution, in which the longitudinal volume is high whereas the side transverse volume is low. This tendency is likewise found for the results of all the measurement conditions. It is found from the results of FIG. 9 that the propagation of the sound of the jet engine has characteristics, as illustrated in FIG. 10. The power has a cylindrical structure so that the sound propagation is characterized to have sound sources in the longitudinal direction of the cylinder.

As a result of the propagation characteristics of FIG. 10, the sound on the side of the engine is generated by synthesizing the longitudinal sounds so that a unique sound propagation appears to have no attenuation with the distance, as plotted in FIG. 7. On the basis of the results thus far described, the structure of a sound-proofing jet engine is designed.

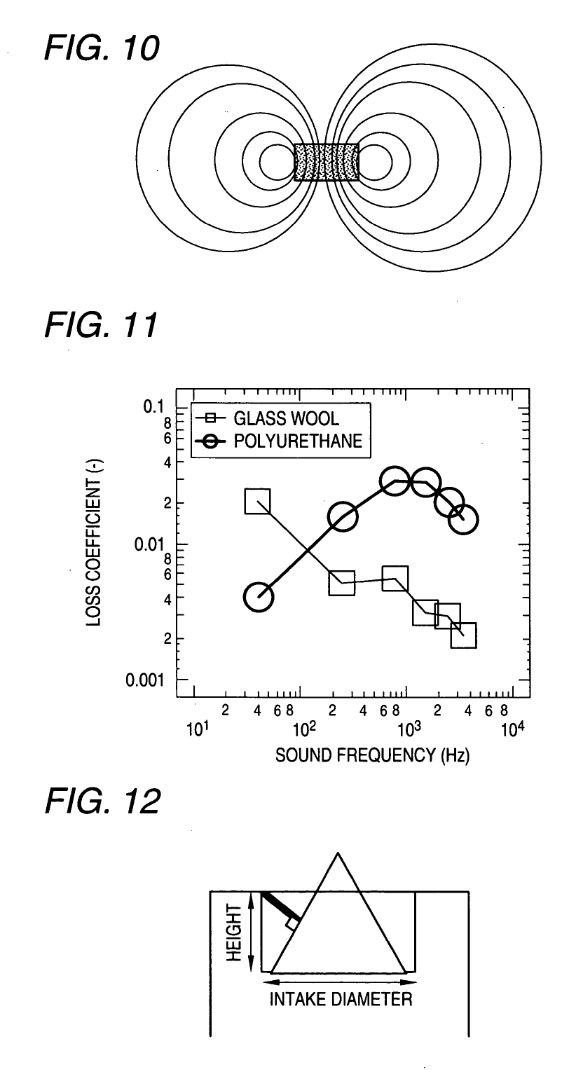

The results of investigations on the sound-proofing structural design are described. The causes for making it difficult to design the sound-proofing structure of the engine are restrictions on the hot backward jet and the center of gravity of the engine. In order to solve the problem of the hot backward jet, the method of combining materials having the characteristics of two kinds is adopted for the sound-absorbing material to form the sound-proofing structure. FIG. 11 illustrates the frequency dependency of the propagation loss characteristics of the composed sound-proofing structures of the two kinds. These sound absorber members of two kinds are glass wool and foamed polyurethane. There are found the characteristics, in which the glass wool has a large sound propagation loss on the low-frequency side whereas the foamed polyurethane has a large sound propagation loss on the high-frequency side. In addition, the glass wool is excellent in heat resistance, but the foamed polyurethane lacks in heat resistance. Therefore, the composite structure in the sound-proofing structural design is made so double that the glass wool is used on the inner circumference side near the jet on the back of the engine whereas the foamed polyurethane is arranged on the outer side of the glass wool.

This double structure is shown in FIG. 1. This new type engine, as shown in FIG. 1, realizes both: the synergetic effect resulting from the combination of the sound absorber members having the opposite frequency characteristics; and the low temperature in the boundary layer of the hot backward jet due to the glass wool having a heat resistance of 400° C. or higher and the backward exhaust of a portion of the intake air, thereby to solve the problem of that hot backward jet.

In order to minimize the sound-proofing space on the intake side thereby to attain the maximum sound-proofing effect, on the other hand, the sound-proofing cone 7 having a triangular cone structure, as shown in FIG. 1, is so arranged in front of the compressor as to cover compressor turbine diameter, and the foamed polyurethane excellent in the high-frequency loss characteristics is arranged on the inner side of the sound-proofing cone 7, as plotted in FIG. 11. The air intake, as manufactured at an initial stage, is characterized to be excellent in the sound-proofing performance, but had a problem that the engine intake efficiency is deteriorated to induce the stalling of the compressor turbine and to lower the cooling efficiency of the hot backward jet utilizing a portion of the intake air.

This problem is caused by the relation, in which the sound-proofing effect and the engine intake efficiency are offsetting each other in the design of the triangular cone structure and the intake portion, as shown in FIG. 1. In order to solve this problem, calculations for optimization have been done on the sound-proofing effect and the intake efficiency of the engine intake structure.

The jet engine intake section area of the structure of FIG. 1 is the area of the frusto-conical side face, as indicated by a solid line in FIG. 12. By using the two numerical values of the buried height of the triangular cone structure and the intake diameter as parameters, therefore, the frusto-conical side face area or the engine intake section area is calculated to derive a value exceeding an exhaust section area of 255 cm².

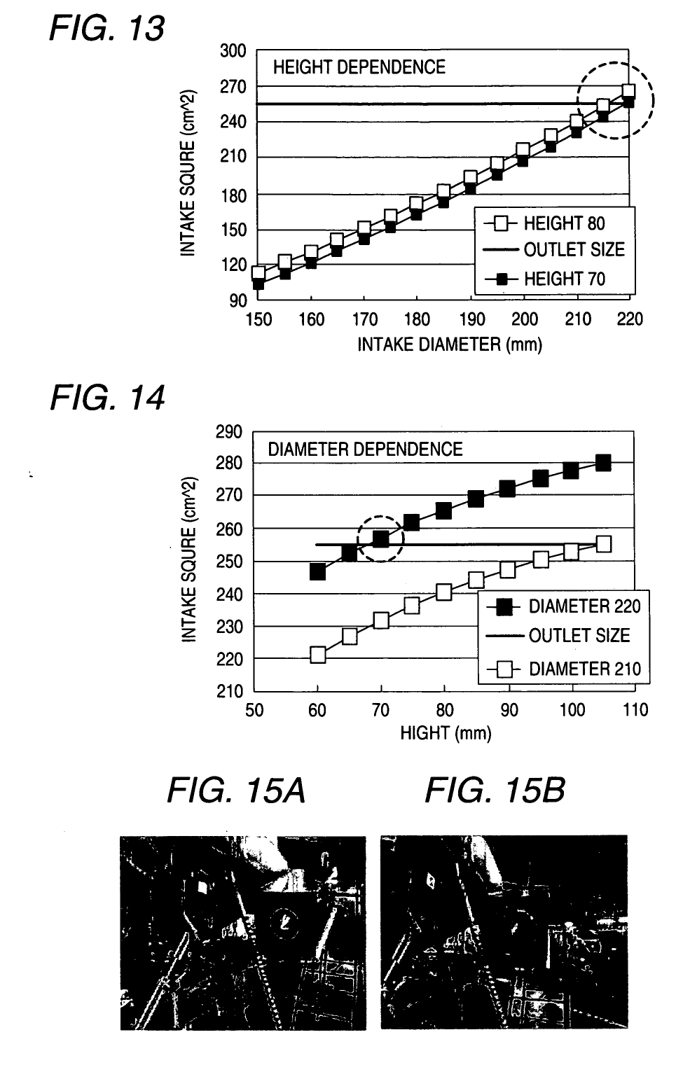

FIG. 13 plots the derivation of the Height parameter value of FIG. 12 exceeding the exhaust section area. It is found from FIG. 13 that the Height parameter is not the parameter having a prominent contribution to the increase in the intake section area. The Height parameter has to be suppressed to a low value, because the allowed space is restricted so that the value to be taken by the Height parameter is restricted.

FIG. 14 plots the calculation results, in which the intake section area is plotted against the parameter of the air intake diameter to contribute prominently to the increase in the intake section area. From FIG. 14, an intake section value exceeding the exhaust section value can be obtained by suppressing the Height parameter as low as 70 mm and by setting the Diameter parameter to 220 mm. The comparison between the air intake thus optimized and the air intake before optimized is shown in FIGS. 15A and 15B. The noise is measured by using the new-type jet engine thus manufactured.

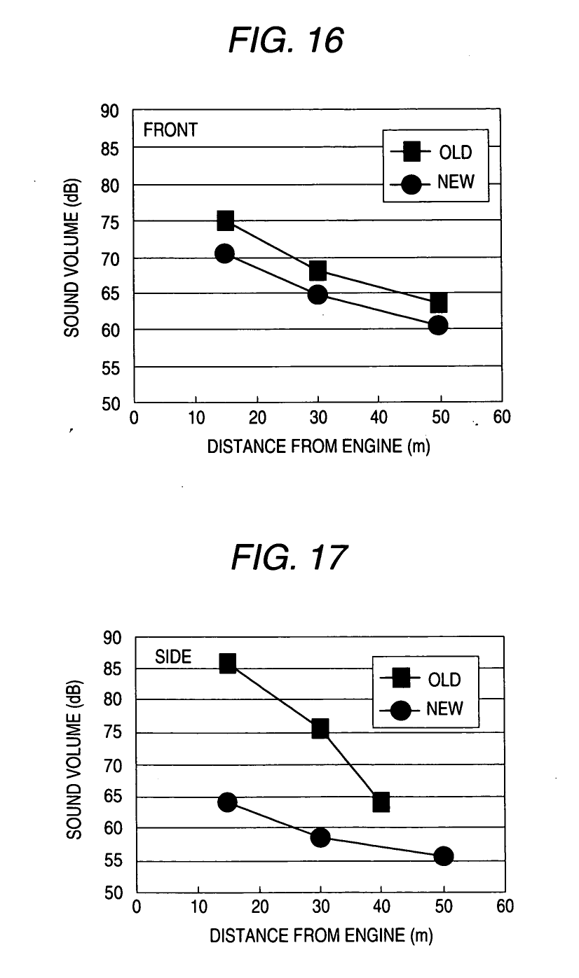

The measurement results of the jet engine according to the invention are described in the following. The jet engine having the sound-proofing structure of the invention and the old engine not using the technique of the invention are run in the twin-engine operation and in the idling operation at 36,000 rpm. The results of these running operations are presented in FIGS. 16, 17 and 18. The comparisons at the maximum power are not presented because they could not be made at the same running speed.

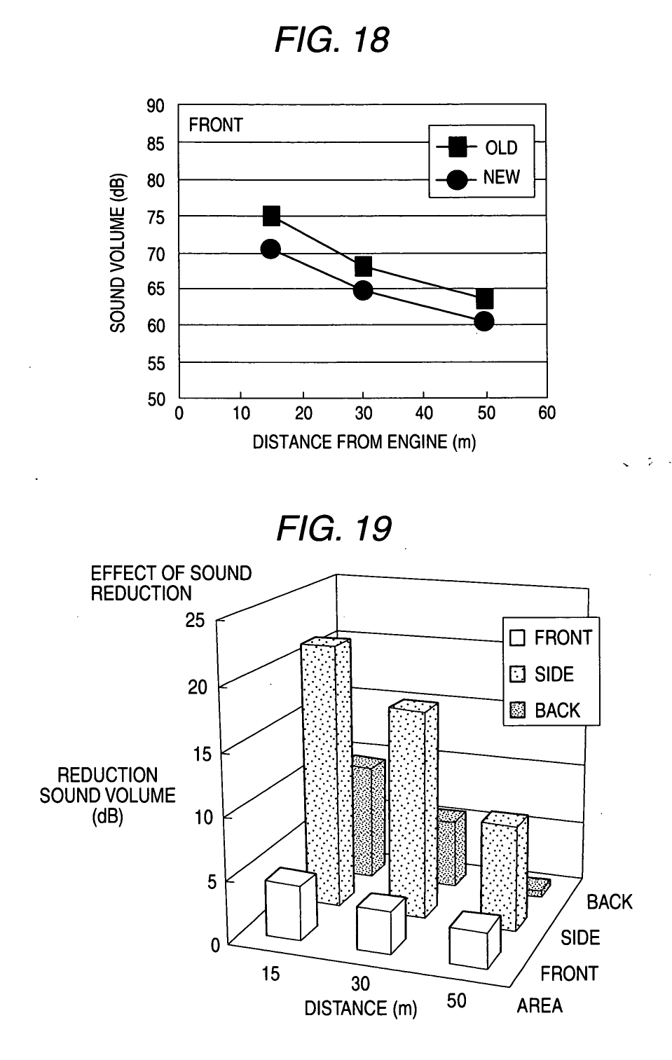

Like the measurements of the old engine: FIG. 16 presents the measurements in front of the engine: FIG. 17 presents those of the engine side; and FIG. 18 presents those of the engine back. From FIGS. 16 to 18, it is found that the noise in the new engine is lower in any direction than those of the old engine. The noise measurement at the place of experiment has a tendency to converge generally into 55 db, but it is found that the values of the new engine reach the convergent values at the side and back.

FIG. 19 presents the directional distribution characteristics of the noise reductions. Outstanding sound attenuation on the side is presented. This indicates that the reduction effect on the side is the synergetic effect of both the front and the back, and supports the propagation characteristics of FIG. 10.

The invention has been conceived by solving the problem belonging to the space moving robot mounting jet engine, which is required to work extremely near a man. The most severe problem or the noise is measured and verified by designing and manufacturing the structure for achieving the prominent sound attenuation. This new engine structure is manufactured by combining the sound absorber members of different frequency characteristics and by designing the optimum shape. The excellent characteristics are confirmed by the bypass air structure in the minimum loss of the jet engine output and in the high cooling effect.

The space moving robot to be used for personal uses is expected for various industrial applications, but requires the engine of the small size, the light weight and the high output, which can work safely extremely near the man. According to the invention, however, the jet engine to work near the man can be safely used. The space moving robot, which can be the most promising for use in the nearest years, is a leisure product such as a hang glider powered by the jet engine of the low noise and the low temperature. The next products are the unmanned aircraft products such as a rescue robot for moving in the air and transporting relief items or a cyclic monitoring flying robot, and are extended to develop to the use of a physical distribution moving machine. Other expectable applications are the transportation of goods between solitary islands, or the quick transportation of catches from the fishing area by large fisherboats.

If the pressure of a high-pressure gas tank using a composite material of carbon fibers is improved from the present pressure of 350 atms. to 700 atms., the space moving robot can be powered in the future by the jet engine using the high-pressure hydrogen gas as its fuel, from the viewpoint of reserving the global environment. This fuel change can contribute to the solution of such a problem of the air pollution with the exhaust gas accompanying the increase in the aircraft as is raised in the small aircraft transportation system (SATS) being investigated at present.

What is claimed is:

1. A jet engine comprising:
a combustor unit arranged at a center thereof;
an intake compressor;
a combustor;
a turbine for driving the intake compressor; and
a fiber sound absorber member disposed on the inner circumference of an exhaust duct around the exhaust side of the combustor unit, the fiber sound absorber member being covered with a net for keeping the shape of the duct inner surface and having a surface exposed to the inside of the duct.

2. The jet engine as set forth in claim 1, further comprising:
a fiber sound absorber member disposed on the inner circumference of an intake duct around the suction side of the combustor unit.

3. The jet engine as set forth in claim 1, wherein
the fiber sound absorber member is glass wool.

4. The jet engine as set forth in claim 1, further comprising:
a second sound absorber member having a sound absorbing frequency band different from that of the fiber sound absorber member, the second sound absorber member being disposed around the fiber sound absorber member.

5. The jet engine as set forth in claim 1, further comprising:
a second sound absorber member having a heat resisting temperature different from that of the fiber sound absorber member, the second sound absorber member being disposed around the fiber sound absorber member.

6. The jet engine as set forth in claim 4, wherein
the second sound absorber member is made of a foamed material.

7. The jet engine as set forth in claim 6, wherein
the foamed material is foamed polyurethane.

8. The jet engine as set forth in claim 6, wherein
the foamed material is foamed metal.

9. The jet engine as set forth in claim 4, further comprising:
a third sound absorber member having a sound absorbing frequency band or a heat resisting temperature different from at least the second sound absorber member, the third sound absorber member being disposed around the second sound absorber member.

10. The jet engine as set forth in claim 1, wherein
a bypass air flow from the intake port for bypassing the combustor is guided in the inner face of the fiber sound absorber member.

11. The jet engine as set forth in claim 10, wherein
the bypass air flow cools the sound absorber member.

12. The jet engine as set forth in claim 10, wherein
the bypass air flow suppresses the exhaust resistance by covering the surface of the sound absorber member with a low-temperature air boundary layer.

13. The jet engine as set forth in claim 1, wherein
the net covering the duct surface is made of a meshed refractory metal.

14. The jet engine as set forth in claim 1, further comprising:
an intake cone disposed a the center of the intake duct of the combustor unit; and
a sound absorber member disposed in the intake cone.

15. The jet engine as set forth in claim 1, wherein
the outer circumference section of the intake cone is equal to or larger than the outer circumference of the combustor unit.

16. The jet engine as set forth in claim 1, wherein
fibers are used as the sound absorber member to lower the noise;
an air boundary layer of low noise is formed by the bypass air flow to lower the temperature; and
the protection at the turbine broken time is ensured by the double-casing having the second sound absorber member and by the meshed refractory metal is given to make the operation extremely near a man.

17. The jet engine as set forth in claim 1, wherein
a hydrogen gas under a high pressure is used as a fuel.

18. The jet engine as set forth in claim 5, wherein
the second sound absorber member is made of a foamed material.

19. The jet engine as set forth in claim 18, wherein
the foamed material is foamed polyurethane.

20. The jet engine as set forth in claim 18, wherein
the foamed material is foamed metal.
